(19) United States
(12) Patent Application Publication
(10) Pub. No.: US 2019/0042672 A1
(43) Pub. Date: Feb. 7, 2019

(54) PRESSURE LOSS DETERMINATION DEVICE, COMPUTER READABLE MEDIUM, AND PRESSURE LOSS DETERMINATION METHOD

(71) Applicant: MITSUBISHI ELECTRIC CORPORATION, Tokyo (JP)

(72) Inventor: Hideyuki SUNADA, Tokyo (JP)

(73) Assignee: MITSUBISHI ELECTRIC CORPORATION, Tokyo (JP)

(21) Appl. No.: 16/075,358

(22) PCT Filed: Mar. 25, 2016
(86) PCT No.: PCT/JP2016/059606

§ 371 Date: Aug. 3, 2018

(51) Int. Cl. G06F 17/50

(52) U.S. Cl. CPC G06F 17/5004

(57) ABSTRACT

A pressure loss determination device (1) is equipped with a route trace unit (30), a piping information management unit (50) and a loss determination unit (40). The route trace unit (30) extracts a plane whereon a pipe is to be arranged from three-dimensional building information, divides the plane into meshes, to be divided into a plurality of cells, and sets a starting point cell being a starting point of the pipe, and an end point cell being an end point of the pipe. The piping information management unit (50) stores loss information (51) indicating a pressure loss value of a fluid between cells. The loss determination unit (40) searches for a plurality of piping routes formed by a connection between cells from the starting point cell to the end point cell, and determines a pressure loss value from the starting point cell to the end point cell with respect to respective piping routes of the plurality of piping routes, using the loss information (51).

### TECHNICAL FIELD

The present invention relates to a device, a program and a method to perform route search of piping, and determine a piping route considering pressure loss, in three-dimensional computer aided design (CAD) data such as building information modeling (BIM) information, etc.

### BACKGROUND ART

As a method to perform route search to minimize a piping route, there is a method to search for a route of the minimum distance by utilizing a Dijkstra's algorithm, etc. and evaluating a section as a node, and a moving distance as the cost of an edge. However, in a case of this method, it is not considered calculation of a cost taking a curve into account, and difference in cost due to passage through the same section in a linear manner, or in a curved manner, etc. Therefore, there is a problem that pressure loss does not always become the smallest even though the distance of the piping route becomes the minimum distance.

In response to this problem, in the conventional techniques, in a case of performing a back-trace of route information after dividing a routing area into meshes, and weighting the routing area with moving distances, when candidates with the same weight appear, a moving direction the same as that in the last time is selected on a priority basis. In this manner, a scheme intended to minimize the cost by a curve is disclosed (e.g. Patent Literature 1).

### CITATION LIST

### Patent Literature

Patent Literature 1: JP 2002-7494 A

### SUMMARY OF INVENTION

### Technical Problem

It is important to minimize pressure loss in piping of air conditioning equipment, etc.; however, even when a distance of a route is the minimum distance, the pressure loss does not always be the smallest. That is, in some cases, even when the distance is long, the pressure loss may be the smallest when the number of curves is small. Further, in a conventional technique, there has been a problem that when a route is judged in a back-trace, a route with more curves may be selected as a result since there is no information on curved components existing ahead.

The present invention is aimed at providing a device, a program and a method to determine a piping route of lower pressure loss.

### Solution to Problem

There is provided according to one aspect of the present invention, a pressure loss determination device including:

a division unit to extract a plane in two dimensions whereon a pipe is to be arranged, from building information in three dimensions into which a building is made into data, to divide the plane extracted into meshes, to be divided into a plurality of cells, and to set a starting point cell being a starting point of the pipe and an end point cell being an end point of the pipe of the plurality of cells;

a loss information storage unit to store, in a case wherein a fluid flows from one cell to another cell being adjacent to the one cell of the plurality of cells via the pipe, loss information indicating a pressure loss value of the fluid between cells; and

a loss determination unit to search for a plurality of piping routes formed by a connection of the cells from the starting point cell to the end point cell, and to determine a pressure loss value in a case wherein the fluid flows from the starting point cell to the end point cell, with respect to each piping route of the plurality of piping routes, using the loss information.

### Advantageous Effects of Invention

According to a pressure loss determination device 1 of the present invention, a loss determination unit determines a piping route from a starting point cell to an end point cell by using loss information. Therefore, it is possible to determine a piping route of lower pressure loss.

### BRIEF DESCRIPTION OF DRAWINGS

FIG. 1 is a diagram according to a first embodiment, and is a block diagram of a pressure loss determination device 1;

FIG. 2 is a diagram according to the first embodiment, and is a diagram illustrating a hardware configuration of the pressure loss determination device 1;

FIG. 3 is a diagram according to the first embodiment, and is a flowchart illustrating an operation of the pressure loss determination device 1;

FIG. 4 is a diagram according to the first embodiment, and is a diagram describing a step S102 of FIG. 3;

FIG. 5 is a diagram according to the first embodiment, and is a diagram describing a step S103 of FIG. 3;

FIG. 6 is a diagram according to the first embodiment, and is a diagram describing a step S104 of FIG. 3;

FIG. 7 is a diagram according to the first embodiment, and is a diagram illustrating a plane 41 wherein a starting point cell 41S and an end point cell 41E are set;

FIG. 8 is a diagram according to the first embodiment, and is a diagram illustrating specific locations of the starting point cell 41S and the end point cell 41E;

FIG. 9 is a diagram according to the first embodiment, and is a diagram illustrating loss information 51;

FIG. 10 is a diagram according to the first embodiment, and is a diagram describing a step S107 of FIG. 3;

FIG. 11 is a diagram according to the first embodiment, and is a diagram describing a step S108 of FIG. 3;

FIG. 12 is a diagram according to the first embodiment, and is a diagram describing a step S109 of FIG. 3;

FIG. 13 is a diagram according to the first embodiment, and is a diagram describing a step S108 for the second time of FIG. 3;

FIG. 14 is a diagram according to the first embodiment, and is a diagram describing a step S109 for the second time of FIG. 3;

FIG. 15 is a diagram according to the first embodiment, and is a diagram describing a step S108 for the second time of FIG. 3;

FIG. 16 is a diagram according to the first embodiment, and is a diagram describing a step S111 of FIG. 3; and

FIG. 17 is a diagram according to the first embodiment, and is a diagram illustrating a second variation.

### DESCRIPTION OF EMBODIMENTS

### First Embodiment

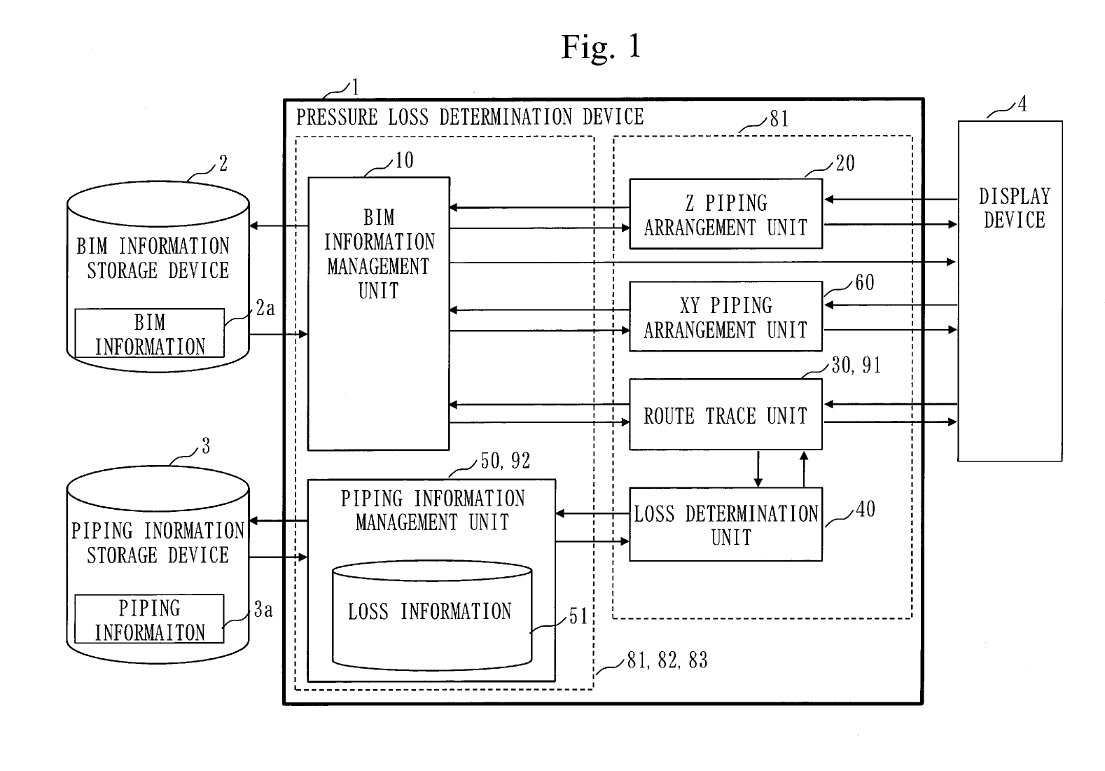

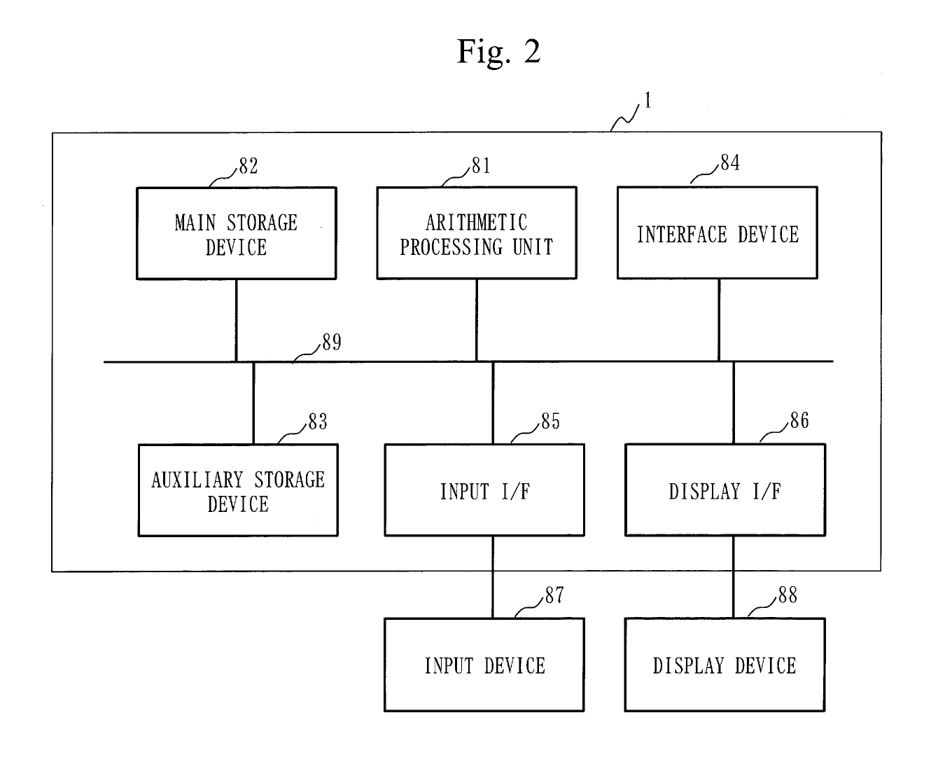

FIG. 1 and FIG. 2 illustrates a block diagram of the pressure loss determination device 1 using a BIM automatic piping system according to the present embodiment, and a hardware (H/W) configuration example in a case wherein the pressure loss determination device 1 is realized by a computer.

FIG. 1 illustrates the block diagram of the pressure loss determination device 1 according to the first embodiment. The pressure loss determination device 1 is an automatic piping device to automatically determine a piping route of lower pressure loss. As illustrated in FIG. 1, the pressure loss determination device 1 is equipped with a BIM information management unit 10, a Z piping arrangement unit 20, a route trace unit 30, a loss determination unit 40, a piping information management unit 50 and an XY piping arrangement unit 60. The route trace unit 30 is a division unit 91. The piping information management unit 50 is a loss information storage unit 92.

The BIM information management unit 10 exchanges information with a BIM information storage device 2 storing BIM information 2a, and the piping information management unit 50 exchanges information with a piping information storage device 3 storing piping information 3a. The piping information management unit 50 acquires loss information 51 to be described below, from the piping information storage device 3, and stores the loss information 51 in a storage device.

FIG. 2 is the diagram illustrating the hardware configuration of the pressure loss determination device 1. The pressure loss determination device 1 is equipped with an arithmetic processing unit 81, a main storage device 82, an auxiliary storage device 83, an interface device 84, an input interface (I/F) 85 and a display I/F 86. The arithmetic processing unit 81 is connected to other hardware components via a signal line 89 to control these hardware components. The input I/F 85 is connected to an input device, and the display I/F 86 is connected to a display device.

The auxiliary storage device 83 stores program to realize functions of the BIM information management unit 10, the Z piping arrangement unit 20, the route trace unit 30, the loss determination unit 40, the piping information management unit 50 and the XY piping arrangement unit 60. Then, operations of these BIM information management unit 10, Z piping arrangement unit 20, route trace unit 30, loss determination unit 40, piping information management unit 50 and XY piping arrangement unit 60 are performed through execution of these program by the arithmetic processing unit 81.

More specifically, as illustrated in FIG. 1, the Z piping arrangement unit 20, the route trace unit 30, the loss determination unit 40 and the XY piping arrangement unit 60 are realized by execution of the program by the arithmetic processing unit 81. Further, the BIM information management unit 10 and the piping information management unit 50 include functions to store BIM information and loss information. Therefore, the BIM information management unit 10 and the piping information management unit 50 are realized by the arithmetic processing unit 81, the main storage device 82 and the auxiliary storage device 83.

A user may execute the pressure loss determination device 1 as a program on a terminal of the user, or as a service via a network.

### Explanation of Operation

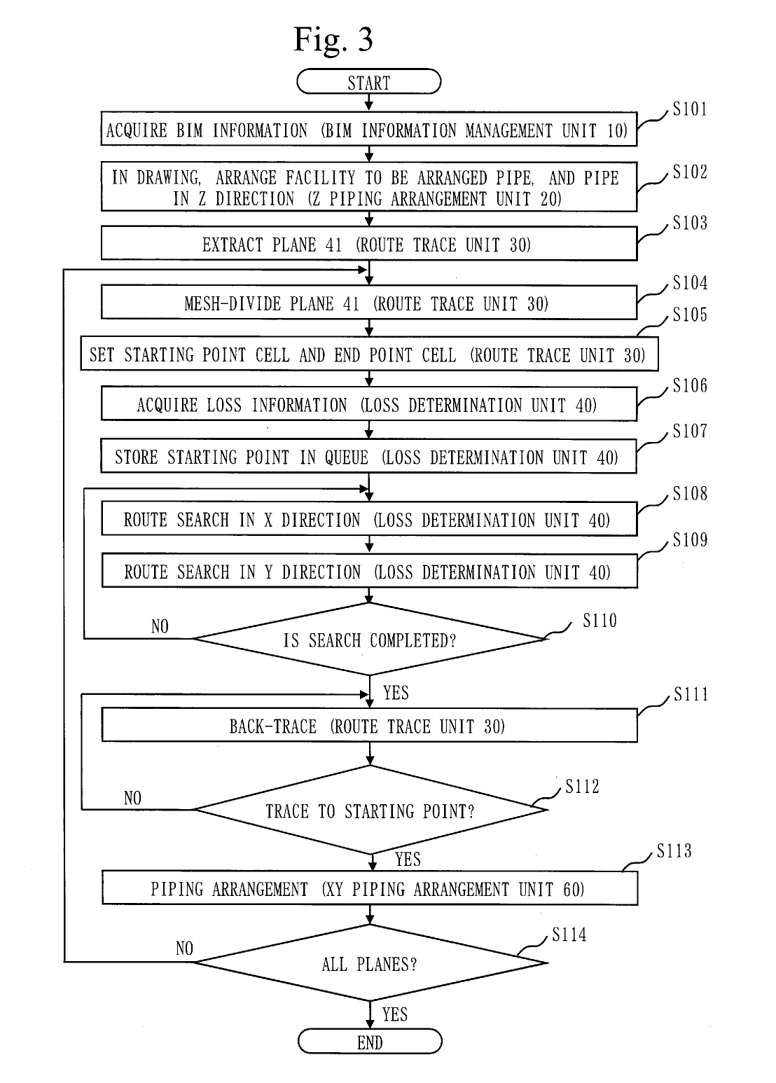

FIG. 3 is a flowchart illustrating an operation of the pressure loss determination device 1. An operation of a pressure loss determination method performed by the pressure loss determination device 1 will be described with reference to FIG. 3. The BIM information management unit 10 described in a step S101 of FIG. 3 indicates a subject of the operation of the step S101. This is the same as in the other steps. In the following explanation of the flowchart, “coordinates” and “coordinate values” appear. In a case of a “coordinate,” it means a “location,” whereas in a case of a “coordinate value,” it means a value of the “coordinate.” A flow of automatic piping by the pressure loss determination device 1 will be described in the following.

<Step S101>

In the step S101, the BIM information management unit 10 retrieves BIM information 2a (including information on a structure of a wall, a floor, etc.) specified by a user from the BIM information storage device 2, and displays drawings of the BIM information 2a on the display device 4. The BIM information 2a is stored in the BIM information storage device 2 in a form of a file, or a database, etc.

<Step S102>

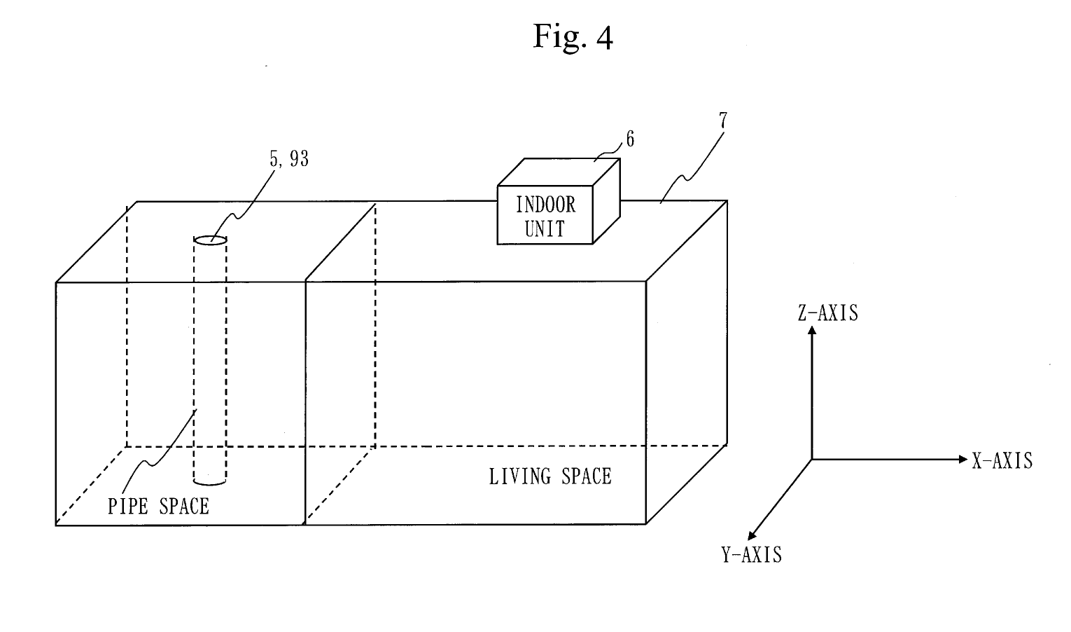

FIG. 4 is the diagram describing a step S102. In the step S102, the Z piping arrangement unit 20 draws a pipe space 5 where a pipe is housed across floors of a building 7, in a drawing on the display device 4, by manipulation of a user via the input I/F 85. The pipe space 5 is a space in a Z direction for arranging a pipe. More specifically, the pipe space 5 is an open ceiling space placed across upper and lower floors, and not a pipe itself. A pipe is made to pass through the inside of the pipe space 5 in a height direction. For coordinates, the height direction of the building 7 is set as a Z-axis, as illustrated in FIG. 4.

<Step S103>

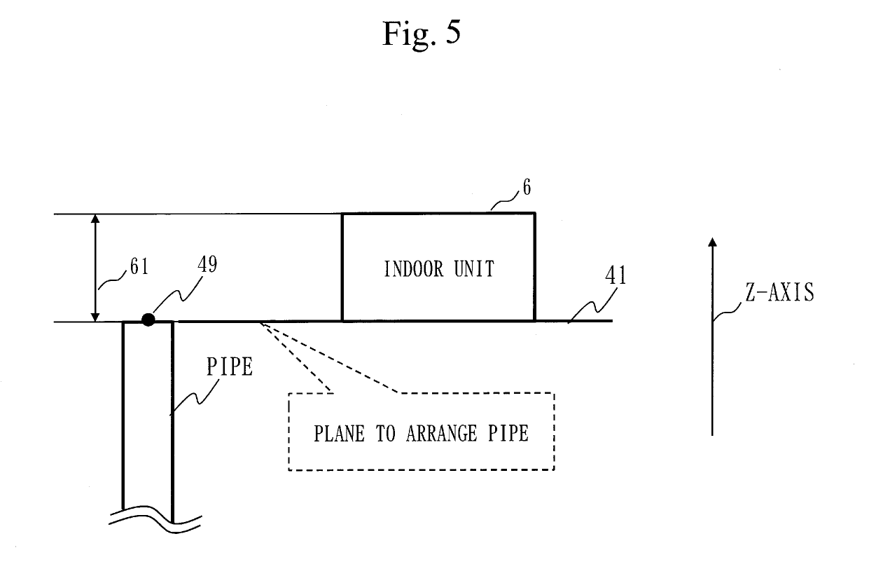

FIG. 5 is a diagram describing a step S103. In the step S103, the route trace unit 30 acquires the BIM information 2a from the BIM information storage device 2 via the BIM information management unit 10 in a case wherein route search of a piping route is requested by a user. The BIM information 2a includes information on the pipe space 5, and the pipe arranged in the Z direction in the pipe space 5, and information on an indoor unit 6. As illustrated in FIG. 5, the route trace unit 30 extracts a plane 41 as a search object wherein a pipe is arranged, from a location of an end portion 49 of the pipe arranged inside the pipe space 5 in the Z direction, and a range 61 of the height of the indoor unit 6 whereto a pipe that has not been connected yet. Generally, the plane 41 corresponds to a ceiling, etc. Here, the indoor unit 6 is a specific example of an apparatus as an object for which a pipe is installed. As described above, the route trace unit 30 extracts the plane 41 being a two-dimensional plane to arrange a pipe therein, from three-dimensional building information (BIM information) wherein the building is made into data.

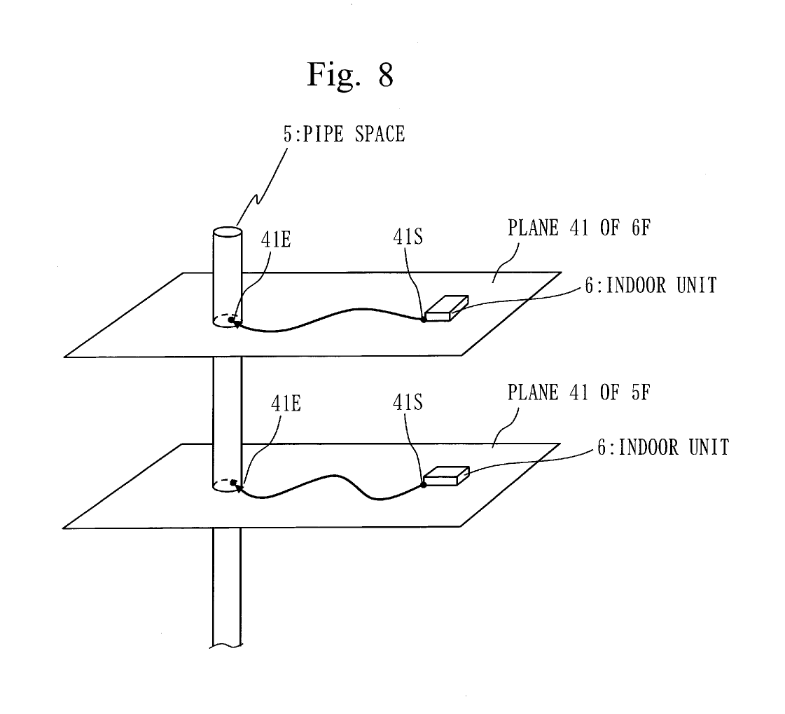

Here, the route trace unit 30 extracts a plurality of planes 41 as illustrated in FIG. 8 as described below. FIG. 8 illustrates a case wherein planes 41 are extracted respectively from the sixth floor and the fifth floor of the building 7. As illustrated, the route trace unit 30 extracts the planes 41 by using information on the pipe space 5 being a pipe space 93, which is placed in the height direction of the building across the floors of the building, inside which a pipe is housed, included in the building information (BIM information), and information on the indoor unit 6 for which a pipe is installed, included in the building information.

<Step S104>

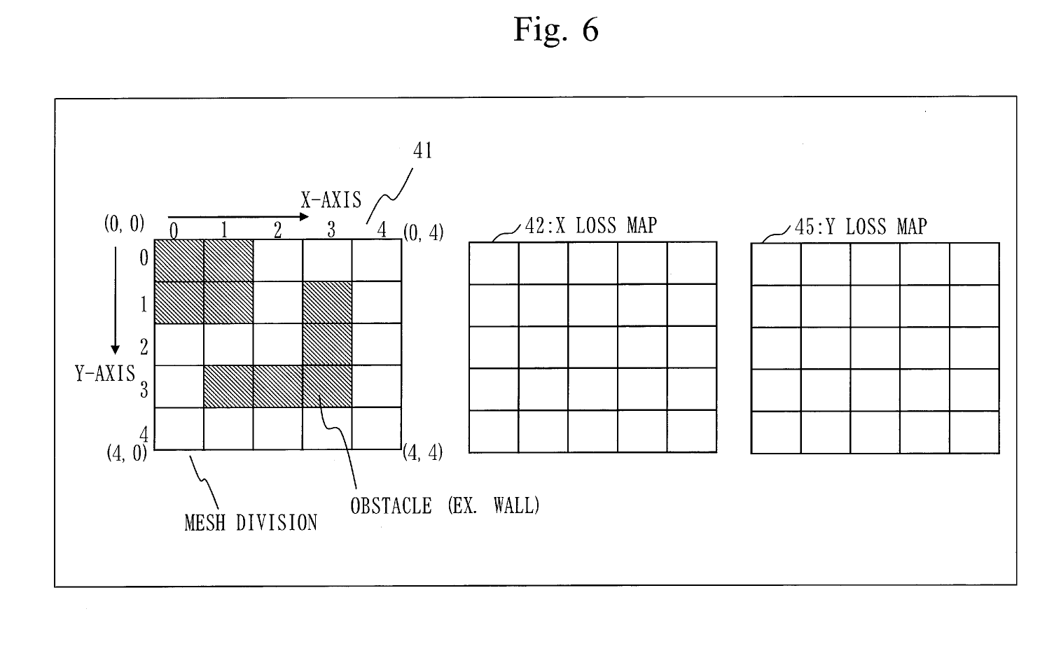

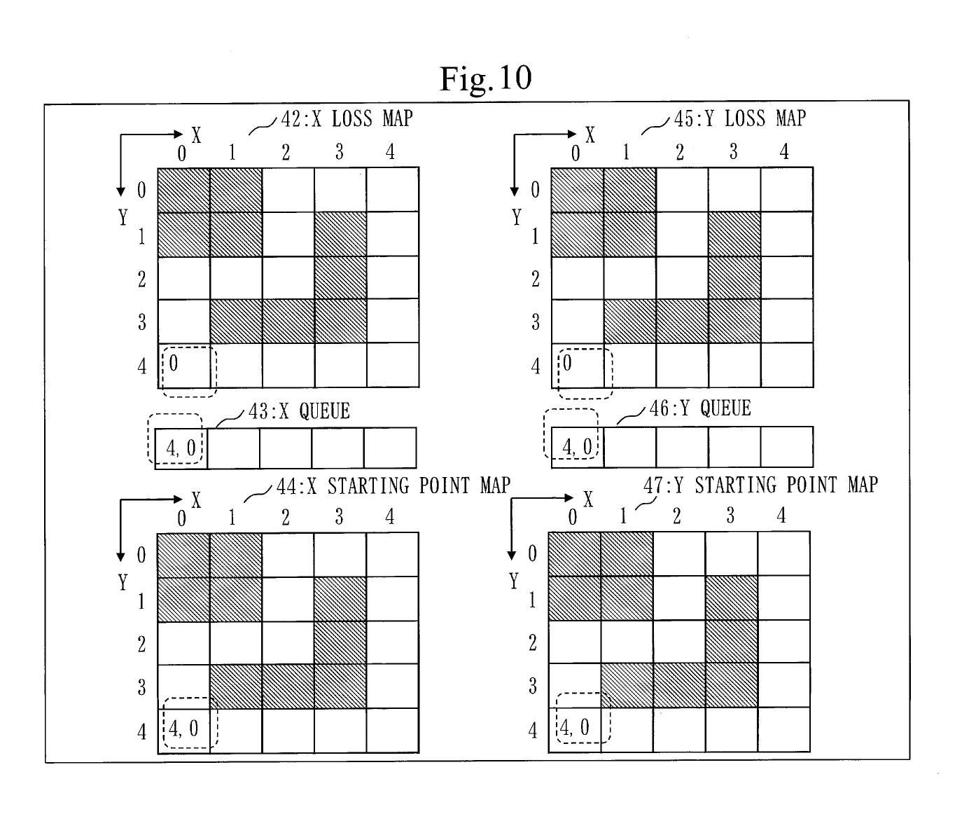

FIG. 6 is a diagram describing a step S104. FIG. 6 illustrates a state wherein a plane 41 is divided into meshes of 25 sections of 5×5. Hereinafter, each of 25 sections is called a cell. As illustrated in FIG. 6, a coordinate (Y, X) is set in the plane 41. Further, in FIG. 6, an X loss map 42 and a Y loss map 45 are illustrated. The route trace unit 30 generates the X loss map 42 and the Y loss map 45. Further, the route trace unit 30 generates an X starting point map 44 and a Y starting point map 47 to be described below in FIG. 10. The X loss map 42 and the Y loss map 45 are divided into 25 pieces of cells of 5×5 corresponding to mesh-division of the plane 41. Furthermore, the X starting point map 44 and the Y starting point map 47 are also divided into 25 pieces of cells of 5×5 corresponding to mesh-division of the plane 41. Coordinates corresponding to the coordinates in the plane 41 which is divided into meshes are set in the loss maps and the starting point maps.

In the step S104, as illustrated in FIG. 6, the route trace unit 30 divides the plane 41 extracted into meshes, to be divided into a plurality of cells. In FIG. 6, the plane 41 is divided into 25 pieces of a plurality of cells of 5×5. The size of one cell as a unit of division can be determined based on designation by a user, the minimum radius of pipes, a thickness of a wall, etc. The size of one cell to be divided into is set beforehand in the route trace unit 30.

Further, the route trace unit 30 generates the X loss map 42 and the Y loss map 45 which are divided into sections corresponding to the plane 41 divided into meshes.

Here, a part in the plane 41 where a wall, etc. exists on the plane 41, and arrangement of a pipe is impossible, is regarded as an obstacle.

In FIG. 6, the obstacle is marked by hatching.

<Step S105>

In a step S105, the route trace unit 30 acquires coordinates of respective objects from the BIM information of the pipe space 5 and the indoor unit 6, and sets starting point cells 41S and end point cells 41E of a piping route to be determined from now, on the plane 41 divided into meshes.

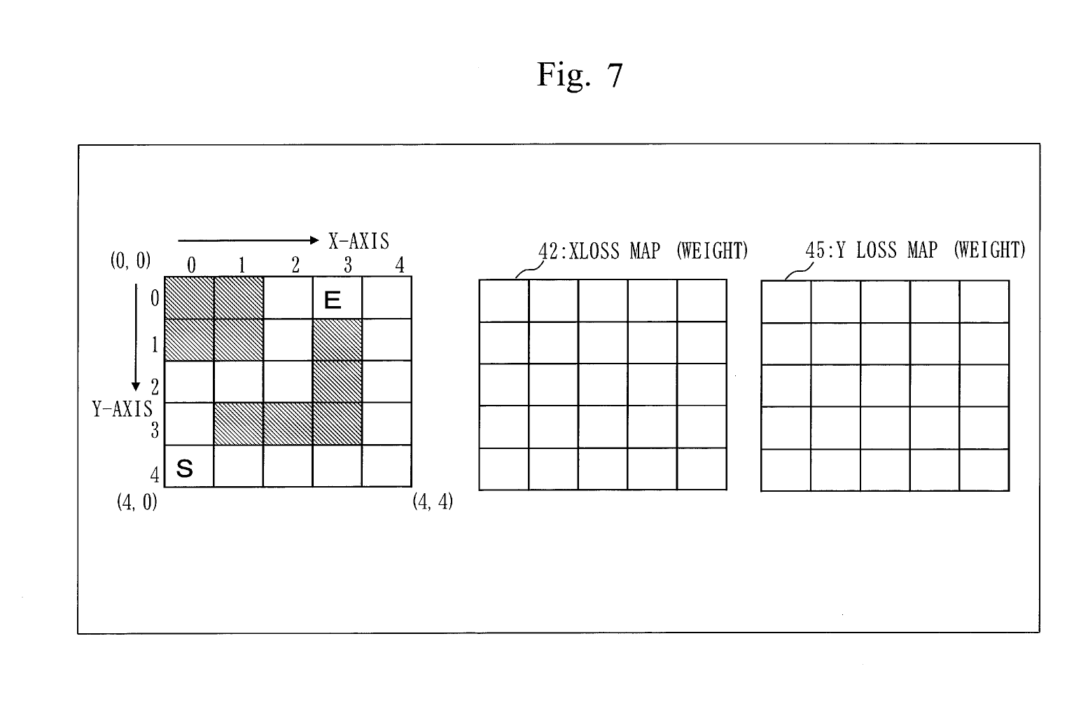

FIG. 7 illustrates a state wherein a starting point cell 41S and an end point cell 41E are set in the plane 41. As illustrated in FIG. 7, the starting point cell 41S is (Y, X)=(4, 0), and the end point cell 41E is (Y, X)=(0, 3).

FIG. 8 is a diagram illustrating specific locations of starting point cells 41S and end point cells 41E. As illustrated in FIG. 8, the starting point cells 41S are piping installment parts of the indoor units 6, and the end point cells 41E are upper end portions of the pipe arranged in a Z direction in the pipe space 5. As described, the route trace unit 30 sets on the plane 41 starting point cells 41S being starting points of a pipe and end point cells 41E being end points of the pipe, out of a plurality of cells.

<Step S106>

In a step S106, the loss determination unit 40 acquires loss information 51 on pressure loss retained by the piping information management unit 50, from the piping information management unit 50. The loss information 51 is information which the piping information management unit 50 acquires from the piping information storage device 3 as piping information 3a.

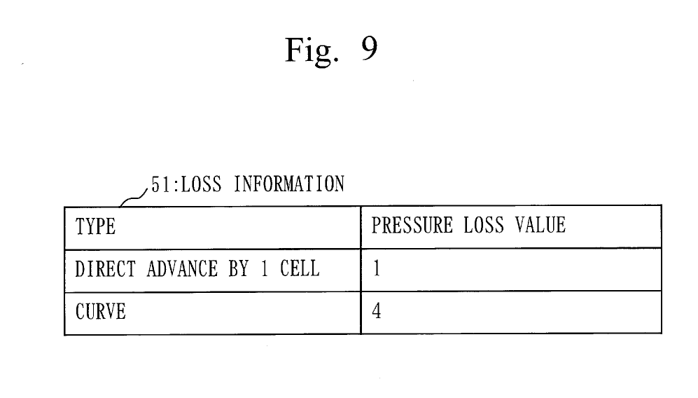

FIG. 9 illustrates an example of the loss information 51 retained by the piping information management unit 50. The loss information 51 is information indicating pressure loss value of a fluid between cells in a case wherein the fluid flows from one cell 41a of the plurality of cells in the plane 41 to another cell 141b adjacent to the one cell 41a via a pipe. FIG. 9 indicates that a pressure loss value increases one by one when the fluid flows over the plane 41 directly straight, and the pressure loss value increases by four when the flow curves at 90 degrees. Hereinafter, the pressure loss value may be called a loss value. Here, the piping information management unit 50 may hold a relation of the pressure loss value between adjacent meshes in a table form, or in an approximation formula, as the loss information 51.

The loss information 51 in FIG. 9 indicates states as follows A case wherein one cell, another cell, and an upstream cell that is adjacent to the one cell on an upstream side of a flow of a fluid, from which the fluid flows into the one cell, are aligned linearly corresponds to “direct advance by one cell”. Further, a case wherein one cell and another cell are aligned linearly, and further, an upstream cell is adjacent to the one cell in either of the right direction or the left direction to a direction from the one cell to the other cell corresponds to “curve”. In FIG. 9, “direct advance by one cell” and “curve” have different values such that the pressure loss values of a fluid between one cell and another cell are 1 and 4, respectively.

<Step S107>

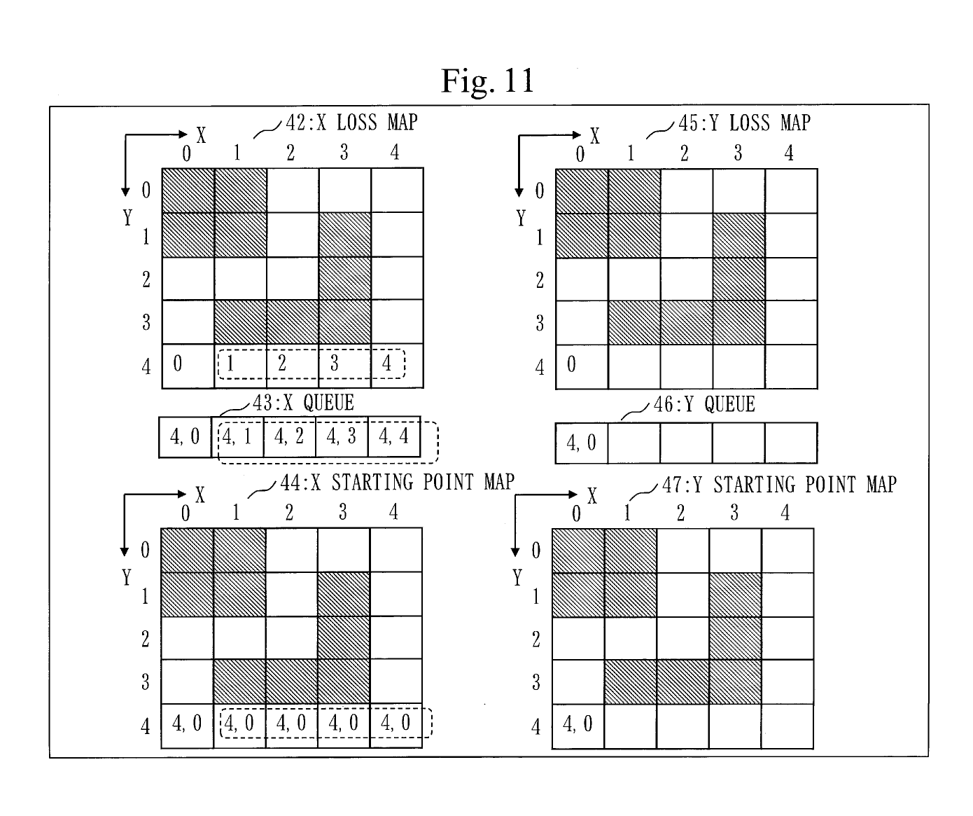

FIG. 10 is a diagram describing a step S107. In FIG. 10, obstacles are marked by hatching for descriptive purposes, in an X loss map 42, a Y loss map 45, an X starting point map 44 and a Y starting point map 47 so as to be easily understandable. This is the same in FIG. 11 through FIG. 15 to be described below. In the loss maps, pressure loss values in cells in the plane 41 are set. The pressure loss values are values taking starting point cells 41S as criteria. In the X loss map 42, a pressure loss value in a case of moving in +X direction or −X direction is set, and in the Y loss map 45, a pressure loss value in a case of moving in +Y direction or −Y direction is set. Further, in the origin maps, coordinate values of starting point cells being cells serving as origins of determination of the pressure loss values determined in the loss maps are set.

Here, in the explanation of FIG. 11 through FIG. 15 below, the loss determination unit 40 is described as moving through cells on the X loss map 42 and the Y loss map 45; however, this is only for descriptive purposes. Practically, the loss determination unit 40 moves through the cells on the plane 41.

In the step S107, the loss determination unit 40 sets a pressure loss value=0 to starting point cells 41S of the X loss map 42 and the Y loss map 45, and stores a coordinate value (4, 0) of the starting point cells 41S in an X queue 43 and a Y queue 46. The queues are realized by the main storage device 82 described in FIG. 2.

Further, the loss determination unit 40 sets a coordinate value (Y, X)=(4, 0) to coordinates of the starting point cells 41S in the X starting point map 44 and the Y starting point map 47.

In FIG. 10, parts set in the step S107 are surrounded by broken-line squares. This is the same in FIG. 11 through FIG. 15.

<Step S108: First Time in X Direction>

FIG. 11 is a diagram describing a step S108. In the step S108, the loss determination unit 40 performs route search in an X direction on the plane 41. In this example, the processing of the step S108 is repeated for three times.

First, the loss determination unit 40 acquires the coordinate value (4, 0) stored in the Y queue 46. Then, the loss determination unit 40 determines, with respect to the X loss map 42, a pressure loss value at the time of direct advance in +X direction and sets the pressure loss value in the X loss map 42, and sets the coordinate value (4, 0) of the starting point cell to the X starting point map 44.

When a loss value is determined, the loss determination unit 40 acquires a loss value of the coordinate value stored in the Y queue 46 from the Y loss map 45, and in a case wherein the coordinate being a subject at the present is other than the starting point S cell 41S, adds a loss value of “curve” and fills one cell by one cell pressure loss values at the time of “direct advance”. The loss determination unit 40 does not set a loss value to a cell with an obstacle, or a cell wherein a loss value smaller than the value desired to fill in has been already recorded. In a case wherein a loss value of the end point cell 41E has been set, and a loss value evaluated is larger than the loss value of the end point cell 41E set, the loss determination unit 40 skips the processing.

In a case wherein the loss determination unit 40 sets a loss value, or updates a loss value, the loss determination unit 40 stores a coordinate value in the X queue 43. The case wherein the loss value is updated is a case wherein it is intended to set, to a cell wherein a loss value has already been set, a loss value smaller than the loss value set. The loss determination unit 40 repeats this until the Y queue 46 becomes empty.

FIG. 11 will be described.

(a) The loss determination unit 40 acquires a loss value=0 of the coordinate value (4, 0) stored in the Y queue 46 from the Y loss map 45. The loss determination unit 40 uses the loss information 51 of FIG. 9 for evaluation of loss. In the X loss map 42, when the route is directed from the coordinate (4, 0) to (4, 4), the loss value increases one by one, in such a manner as 1, 2, 3 and 4.
(b) Since all the starting point cells of the loss values 1, 2, 3 and 4 of the X loss map 42 are the coordinate value (4, 0), the loss determination unit 40 sets the coordinate value (4, 0) to the cells of the coordinates (4, 1) through (4, 4) of the X starting point map 44.
(c) The loss determination unit 40 sets the coordinate values of the coordinates (4, 1), (4, 2), (4, 3) and (4, 4) of the X loss map 42 wherein the loss values are set, to the X queue 43.
(d) By (a) through (c) described above, the X loss map 42, the X queue 43 and the X starting point map 44 become the states in FIG. 11.

<Step S109: First Time in Y Direction>

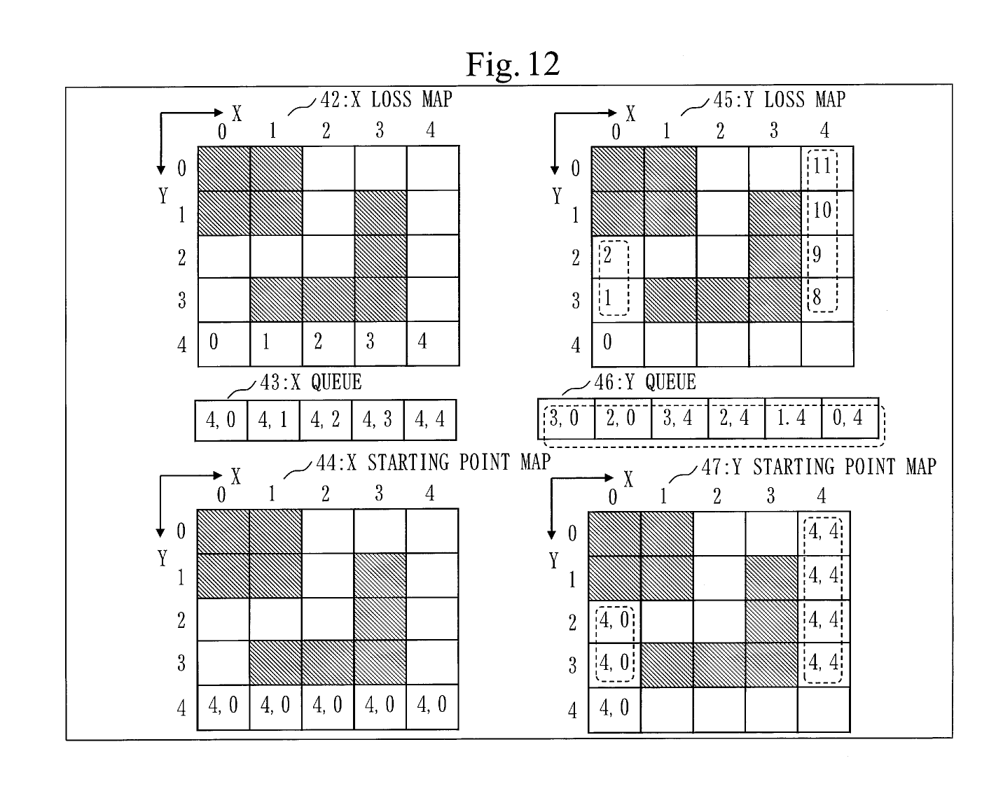

FIG. 12 is a diagram describing a step S109. In the step S109, the loss determination unit 40 performs route search in a Y direction on the plane 41. In this example, the processing of the step S109 is repeated twice.

The loss determination unit 40 acquires coordinate values stored in the X queue 43 similarly as in the case of route search in the X direction of the step S108, and fills one cell by one cell in the Y loss map 45 and the Y starting point map 47 pressure loss values at the time of “direct advance”, and coordinates of starting point sections at present.

The loss determination unit 40 acquires loss values of the coordinate values stored in the X queue 43 from the X loss map 42, and in a case wherein a coordinate of a subject at present is other than the starting point cell 41S, adds loss values of “curve”, and fills one cell by one cell the pressure loss values at the time of “direct advance”.

The loss determination unit 40 does not set a loss value for a section with an obstacle or a cell wherein a loss value smaller than a loss value desired to be filled in has already been set, similarly as in the case of route search in the X direction.

The loss determination unit 40 stores coordinate values in the Y queue 46 in a case wherein loss values are set or updated.

The loss determination unit 40 repeats this until the X queue 43 becomes empty.

FIG. 12 will be described. The loss determination unit 40 acquires the coordinate values stored in the X queue 43, and fills the cells of the Y loss map 45 and the Y starting point map 47 as described below.

(a) The loss determination unit 40 acquires a coordinate value (4, 0) from the X queue 43. On the plane 41, it is possible to proceed in −Y direction out of +Y direction and −Y direction, from the coordinate value (4, 0). The loss determination unit 40 sets loss values 1 and 2 to the coordinates (3, 0) and (2, 0) of the Y loss map 45.
(b) At the time of setting the loss values 1 and 2, the loss determination unit 40 sets the coordinate value (4, 0) in the X queue 43 wherein a loss value 0 being a basis for calculation of the loss values 1 and 2 is set, to coordinates (3, 0) and (2, 0) of the Y starting point map 47, and further, sets the coordinate values (3, 0) and (2, 0) to the Y queue 46.
(c) The loss determination unit 40 acquires a coordinate value (4, 1) from the X queue 43. Since there is an obstacle, it is impossible to proceed in any of +Y direction and −Y direction from the coordinate of the coordinate value (4, 1). The loss determination unit 40 acquires a next coordinate value from the X queue 43.
(d) The loss determination unit 40 acquires a coordinate value (4, 2) from the X queue 43. Since there is an obstacle, it is impossible to proceed in any of +Y direction and −Y direction from the coordinate of the coordinate value (4, 2). The loss determination unit 40 acquires a next coordinate value from the X queue 43.
(e) The loss determination unit 40 acquires a coordinate value (4, 3) from the X queue 43. Since there is an obstacle, it is impossible to advance in any of +Y direction and −Y direction from the coordinate of the coordinate value (4, 3). The loss determination unit 40 acquires a next coordinate value from the X queue 43.
(f) The loss determination unit 40 acquires a coordinate value (4, 4) from the X queue 43. It is possible to proceed in −Y direction from the coordinate of the coordinate value (4, 4). That is, it is possible to proceed to a coordinate (0, 4) from the coordinate (4, 4). The loss determination unit 40 sets loss values 8, 9, 10 and 11 to coordinates (3, 4), (2, 4), (1, 4) and (0, 4) of the Y loss map 142. The loss value of the coordinate (3, 4) becomes 8 since the coordinate (3, 4) corresponds to “curve” in FIG. 9 with respect to the coordinate value (4, 4) of the X queue 43 being the starting point cell.
(g) The loss determination unit 40 sets the coordinate value (4, 4) of the starting point cell in the X queue 43 wherein a loss value 4 being a basis for calculation of the loss values 8, 9, 10 and 11, to coordinates (3, 4), (2, 4), (1, 4) and (0, 4) of the Y starting point map 47 at the time of setting the loss values 8, 9, 10 and 11.
(h) The loss determination unit 40 sets the coordinate values (3, 4), (2, 4), (1, 4) and (0, 4) in the Y queue 46.

<Step S110>

In a step S110, the loss determination unit 40 judges whether the route search is completed. The loss determination unit 40 repeats the step S108 through the step S109 until the coordinate values in the X queue 43 and the Y queue 46 become empty. In this example, X direction search for the second and third times, and Y direction search for the second time continue.

<S108: Search in X direction for the Second Time>

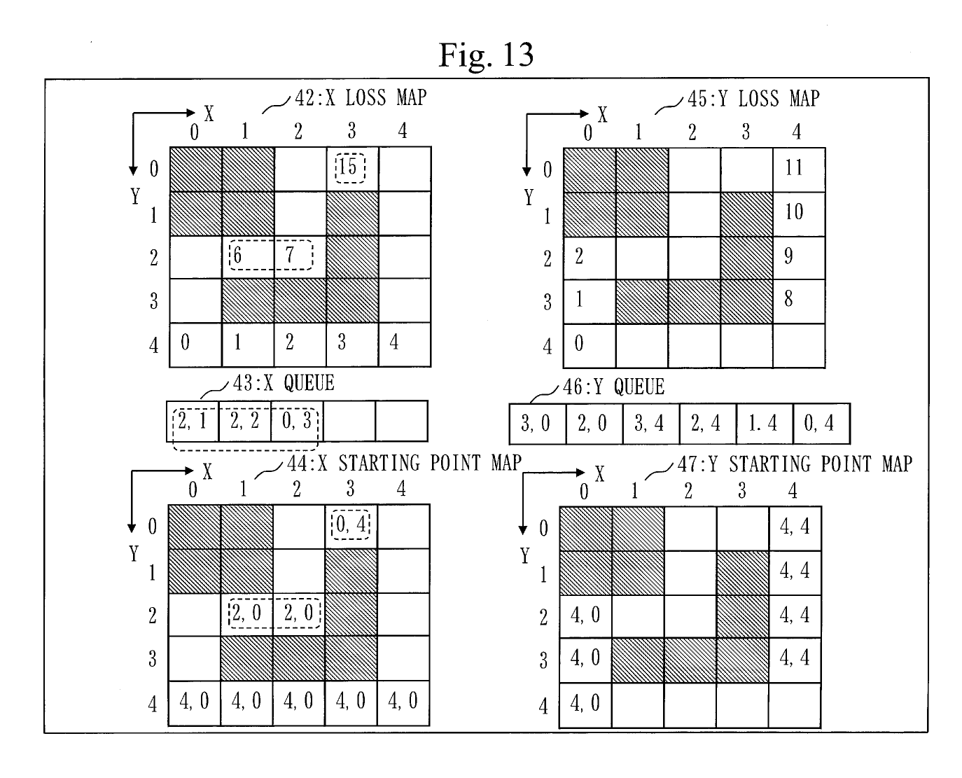

FIG. 13 is a diagram describing the step S108 for the second time. FIG. 13 will be described.

(a) The loss determination unit 40 acquires a coordinate value (3, 0) from the Y queue 46. Since there is an obstacle, it is impossible to proceed in any of +X direction and −X direction from the coordinate value (3, 0). The loss determination unit 40 acquires a next coordinate value from the Y queue 46.
(b) The loss determination unit 40 acquires a coordinate value (2, 0) from the Y queue 46. It is possible to proceed in +X direction from the coordinate of the coordinate value (2, 0). That is, it is possible to proceed from the coordinate (2, 0) toward a coordinate (2, 2). The loss determination unit 40 sets loss values 6 and 7 to coordinates (2, 1) and (2, 2) of the X loss map 42. The loss value of the coordinate (2, 1) becomes 6 since the coordinate (2, 1) corresponds to “curve” with respect to the coordinate value (2, 0) of the Y queue 46 being the starting point.
(c) At the time of setting the loss values 6 and 7, the loss determination unit 40 sets the coordinate value (2, 0) of the starting point cell in the Y queue 46 wherein a loss value 2 being a basis for calculation of the loss values 6 and 7 is set, to the coordinates (2, 1) and (2, 2) of the X starting point map 44.
(d) Further, the loss determination unit 40 sets the coordinate values (2, 1) and (2, 2) to the X queue 43.
(e) The loss determination unit 40 acquires coordinate values (3, 4), (2, 4) and (1, 4) from the Y queue 46; however, it is impossible to proceed in any of +X direction and −X direction from the coordinates of these coordinate values. The loss determination unit 40 acquires a next coordinate value from the Y queue 46.
(f) The loss determination unit 40 acquires a coordinate value (0, 4) from the Y queue 46. It is possible to proceed in −X direction from the coordinate of the coordinate value (0, 4). It is possible to proceed from the coordinate (0, 4) toward the coordinate (0, 3). The coordinate (0, 3) is the end point E. The loss determination unit 40 sets a loss value 15 to the coordinate (0, 3) of the X loss map 42. The loss value of the coordinate (0, 3) is 15 since the coordinate (0, 3) corresponds to “curve” with respect to the coordinate value (0, 4) in the Y queue 46 being the starting point.
(g) The loss determination unit 40 sets the coordinate (0, 4) of the starting point cell in the Y queue 46 wherein a loss value 11 being a basis for calculation of the loss value 15 is set, to the coordinate (0, 3) of the X starting point map 44, at the time of setting the loss value 15. The loss determination unit 40 sets the coordinate value (0, 3) in the X queue 43.

<S109: Y Direction Search for the Second Time>

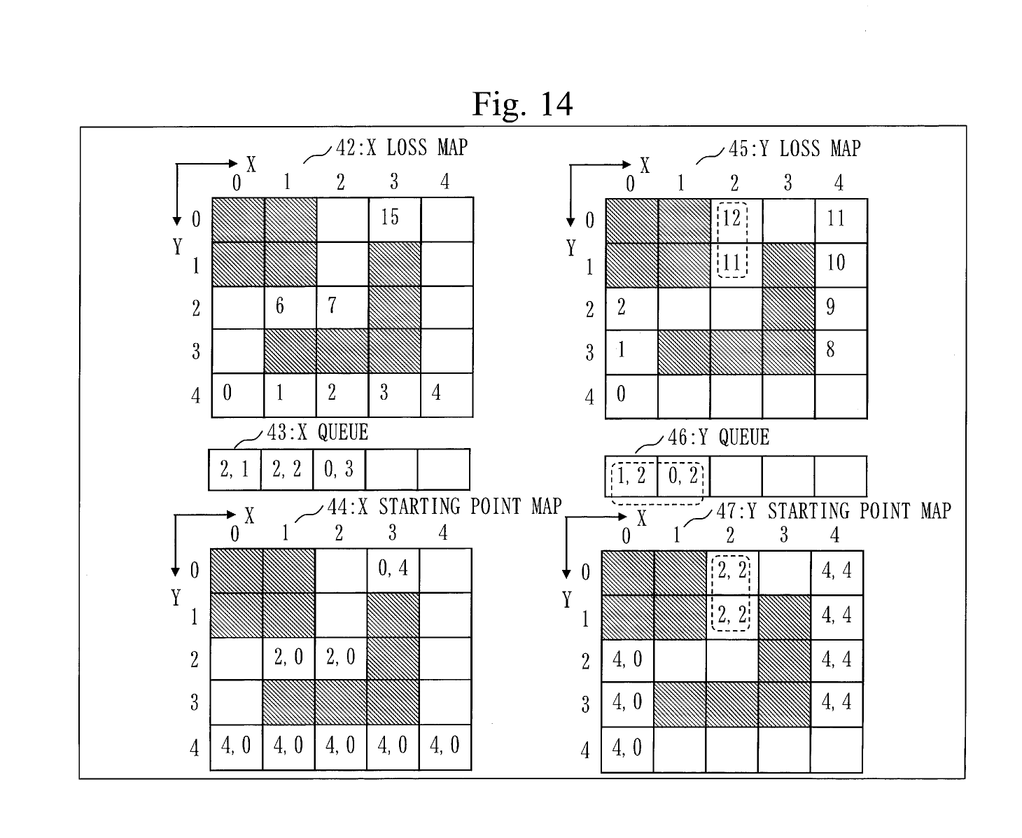

FIG. 14 is a diagram describing the step S109 for the second time. FIG. 14 will be described.

(a) The loss determination unit 40 acquires a coordinate value (2, 1) from the X queue 43. It is impossible to proceed any of +Y direction and −Y direction from the coordinate of the coordinate value (2, 1). The loss determination unit 40 acquires a next coordinate value from the X queue 43.
(b) The loss determination unit 40 acquires a coordinate value (2, 2) from the X queue 43. It is possible to proceed in −Y direction from the coordinate of the coordinate value (2, 2). That is, it is possible to proceed from the coordinate (2, 2) to the coordinates (1, 2) and (0, 2). The loss determination unit 40 sets loss values 11 and 12 to the coordinates (1, 2) and (0, 2) of the Y loss map 45. The loss value of the coordinate (1, 2) becomes 11 since the coordinate (1, 2) corresponds to “curve” with respect to the coordinate value (2, 2) of the X queue 43 being the starting point.
(c) The loss determination unit 40 sets a coordinate value (2, 2) of the starting point cell in the Y queue 46 wherein a loss value 7 being a basis for calculation of the loss values 11 and 12 are set, to the coordinates (1, 2) and (0, 2) of the Y starting point map 47. Further, the loss determination unit 40 sets the coordinate values (1, 2) and (0, 2) in the Y queue 46.
(d) The loss determination unit 40 acquires a coordinate value (0, 3) from the X queue 43. The coordinate value (0, 3) is the end point cell 41E. Accordingly, the loss determination unit 40 completes the route search in the Y direction for the second time.

<S108: X Direction Search for the Third Time>

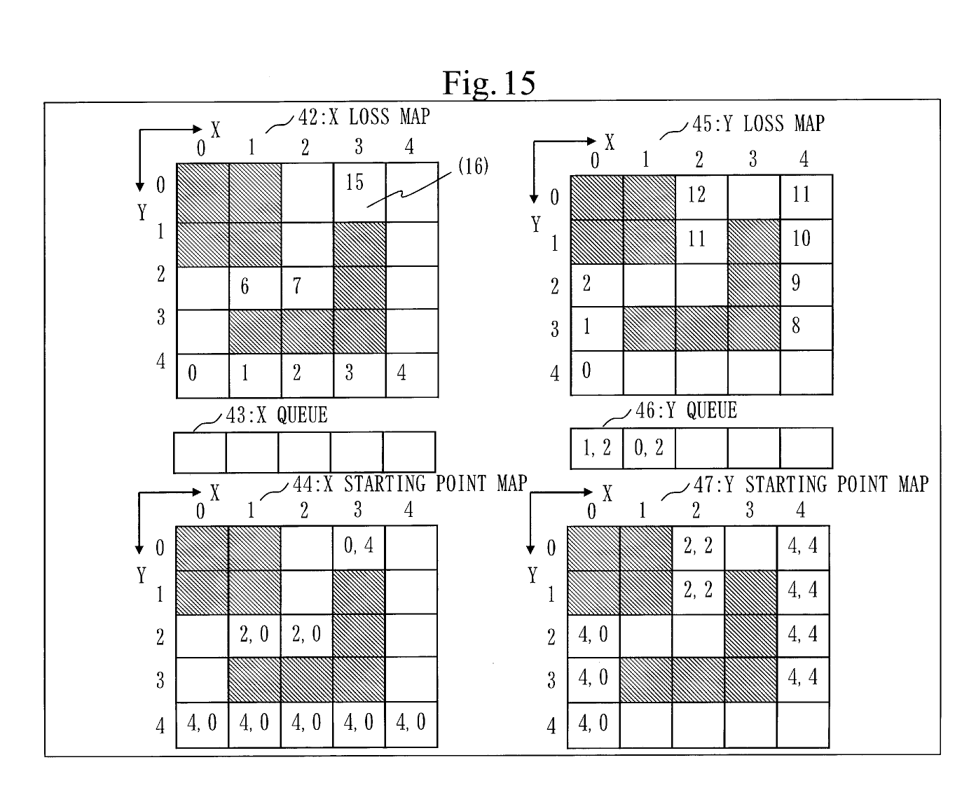

FIG. 15 is a diagram describing the step S108 for the third time. FIG. 15 will be described.

(a) The loss determination unit 40 acquires a coordinate value (1, 2) from the Y queue 46. It is impossible to proceed in any of +X direction and −X direction from the coordinate of the coordinate value (1, 2). The loss determination unit 40 acquires a next coordinate value from the Y queue 46.
(b) The loss determination unit 40 acquires a coordinate value (0, 2) from the Y queue 46. It is possible to proceed to the coordinate (0, 3) in +X direction from the coordinate of the coordinate value (0, 2). The coordinate (0, 3) is the end point cell 41E. In a case of proceeding from the coordinate (0, 2) to the coordinate (0, 3), a loss value is 16. Hence this is larger than the loss value that has already been set in the end point cell 41E, the loss determination unit 40 does not set the loss value 16. The loss value becomes 16 since it corresponds to “curve” with respect to the coordinate value (0, 2) of the Y queue 46 being the starting point.
(c) The loss determination unit 40 completes the route search in the X direction since the Y queue 46 becomes empty, and the end point cell 41E is reached. Processing proceeds to a step S111.
(d) In this case, the loss determination unit 40 has searched for a first piping route of the coordinate (4, 0)→the coordinate (4, 4)→the coordinate (0, 4)→the coordinate (0, 3), and a second piping route of the coordinate (4, 0)→the coordinate (2, 0)→the coordinate (2, 2)→the coordinate (0, 2)→the coordinate (0, 3). The loss determination unit 40 sets loss values in the search process to the loss maps. In this manner, the loss determination unit 40 determines pressure loss values of a fluid in respective cells in respective piping routes on the plane 41, in a case of searching for a plurality of piping routes, by using the loss information 51.

Further, the loss determination unit 40 searches for a plurality of piping routes like the first piping route or the second piping route formed by a connection of a plurality of cells from the starting point cell 41S to the end point cell 41E, and determines pressure loss values in a case wherein a fluid flows from the starting point cell 41S to the end point cell 41E with respect to respective piping routes of the plurality of piping routes, by using the loss information 51.

<Step S111>

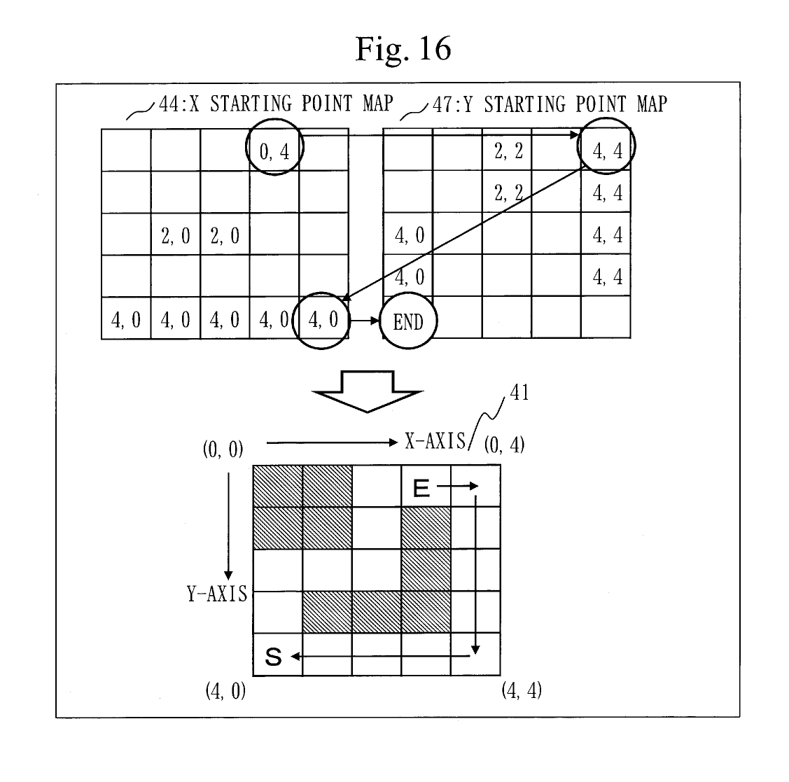

FIG. 16 is a diagram describing the step S111. In the step S111, the route trace unit 30 acquires a smaller value of the loss values of the end points E from the X loss map 42 and the Y loss map 45, and performs a back-trace of the piping route by using the corresponding X starting point map 44 and Y starting point map 47. In this example, the processing is as follows:

(a) The route trace unit 30 acquires a loss value 15 of the end point E in the X loss map 42.
(b) The route trace unit 30 acquires, based on the coordinate of the end point cell 41E in the X starting point map 44, a coordinate value (0, 4) which is set in that coordinate.
(c) The route trace unit 30 refers to a coordinate (0, 4) of the Y starting point map 47 based on the coordinate value (0, 4), and acquires a coordinate value (4, 4) of the coordinate (0, 4).
(d) The route trace unit 30 refers to the coordinate (4, 4) of the X starting point map 44 based on the coordinate value (4, 4), and acquires a coordinate value (4, 0) which is set in the coordinate (4, 4).
(e) The route trace unit 30 reaches the starting point cell 41S from the coordinate value (4, 0). Accordingly, the back-trace is completed.

By the back-trace, the piping route of the starting point cell 41S→the coordinate (4, 4)→the coordinate (0, 4)→the end point cell 41E is specified. The piping route is a route of the lowest pressure loss on the plane 41.

<Step S112>

In a case wherein the back-trace to the starting point cell 41S is completed, the route trace unit 30 completes processing (YES in the step S112).

<Step S113>

In a step S113, the XY piping arrangement unit 60 arranges a pipe that passes through the piping route of the lowest pressure loss value specified by the back-trace, in an electronic drawing of BIM.

<Step S114>

In a step S114, the XY piping arrangement unit 60 performs the processing from the step S104 through the step S114 on respective planes 41 of the plurality of planes 41 extracted in the step S103.

### Effect of First Embodiment

In the pressure loss determination device 1 of the first embodiment, the loss determination unit 40 determines a piping route from the starting point cell 41S to the end point cell 41E using the loss information 51. Thus, it is possible to determine a piping route of lower pressure loss.

In the pressure loss determination device 1 of the first embodiment, pressure loss is evaluated using a plurality of loss maps for loss evaluation corresponding to moving directions, and a plurality of starting point maps that hold starting point information to be used for back-trace, for evaluation of the pressure loss. Thus, it is possible for the pressure loss determination device 1 to extract a piping route of lower pressure loss with a simple configuration.

### First Variation

In the first embodiment described above, the “curve” in the loss information 51 of FIG. 9 indicates a case of an angle of 90 degrees in the plane 41. As a variation, it is possible to apply the explanation as follows to a case wherein a curved pipe at an angle different from 90 degrees is used. As a specific example, in order to cope with a curved pipe at an angle of 45 degrees, a loss map and a starting point map for the curved pipe at an angle of 45 degrees are used respectively. Further, as a parameter of pressure loss, information in a case of 45 degrees is retained.

### Second Variation

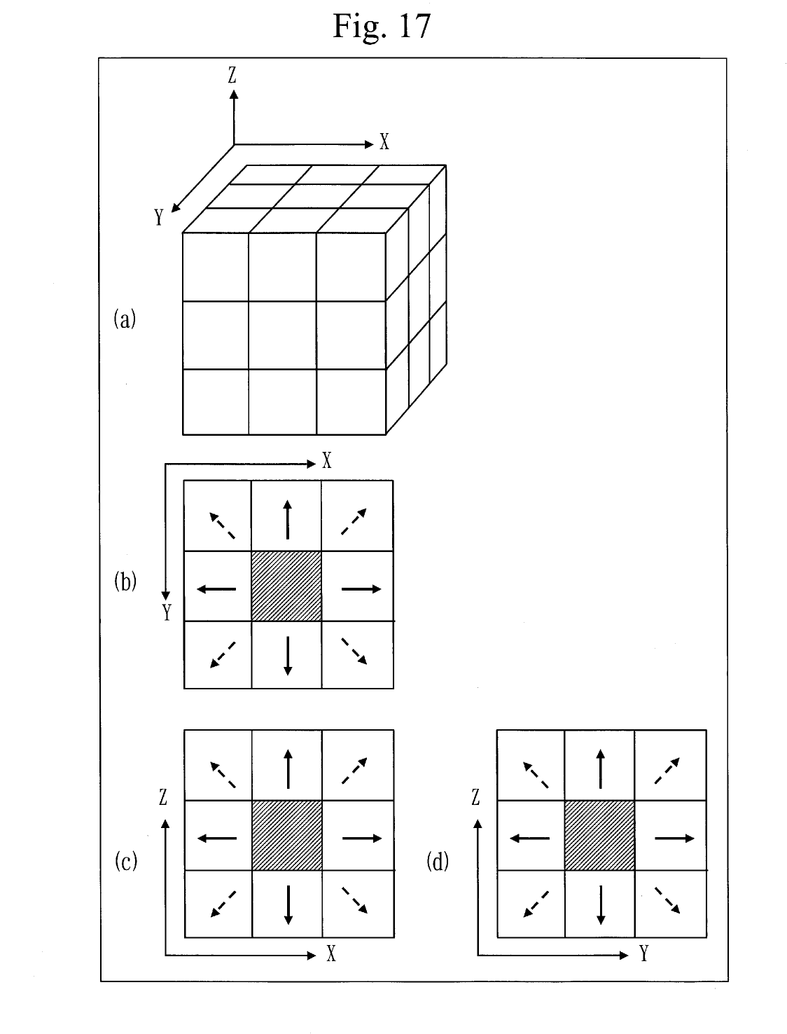

FIG. 17 is a diagram illustrating a second variation. In the first embodiment above, the pressure loss determination device 1 searches for a piping route using the plane 41. As a second variation, the route trace unit 30 extracts a rectangular parallelepiped as illustrated in FIG. 17 in order to determine a three-dimensional piping route instead of the plane 41. FIG. 17 is a diagram describing a determination method of a three-dimensional piping route. The route trace unit 30 extracts a rectangular parallelepiped illustrated in (a) of FIG. 17. The route trace unit 30 divides the rectangular parallelepiped extracted into a plurality of cells. In the first embodiment above, the loss determination unit 40 performs route search in the X direction and a route search in the Y direction. In the second variation, the loss determination unit 40 performs route search in three dimensions on the rectangular parallelepiped. (b) through (d) of FIG. 17 illustrate directions of route search by the loss determination unit 40. As in (b) of FIG. 17, when viewed in an XY plane, it is possible for the loss determination unit 40 to advance the route in eight directions from a cell being a basis shown by oblique lines. Further, as in (c) and (d) of FIG. 17, when viewed in an XZ plane and a YZ plane, it is possible in both cases for the loss determination unit 40 to advance the route in eight directions from cells being bases. When a rectangular parallelepiped is extracted, a three-dimensional piping route is searched for, and pressure loss is evaluated in three dimensions, a plurality of loss maps, a plurality of starting point maps and a plurality of queues are used.

### Third Variation

A third variation is a case wherein the pressure loss determination device 1 described above in the first embodiment is used integrally with a CAD tool including functions of structure design, etc. The pressure loss determination device 1 described above in the first embodiment may be configured to be connected with a CAD device wherein software of a CAD tool is embedded to exchange data with each other. Otherwise, a pressure loss determination program to realize the pressure loss determination device 1 may be configured to be included in a CAD program being a CAD tool. By these configurations, it is possible to efficiently process both of piping design, and structure design other than the piping design, etc.

### Fourth Variation

A fourth variation builds a web service whereby BIM information including a determination result of automatic piping by the pressure loss determination device 1 can be uploaded via a network, and the BIM information including the determination result of automatic piping can be downloaded. By this web service, it is possible for a user who needs the determination result of automatic piping to easily acquire the determination result of automatic piping.

### Explanation of Hardware Configuration

Lastly, supplementary explanation of a hardware configuration of the pressure loss determination device 1 will be provided. The arithmetic processing unit 81 illustrated in FIG. 2 is an integrated circuit (IC) to perform processing. The arithmetic processing unit 81 is a central processing unit (CPU), a digital signal processor (DSP), etc. The main storage device 82 and the auxiliary storage device 83 illustrated in FIG. 2 are random access memories (RAMs), read only memories (ROMs), flash memories, hard disk drives (HDDs), etc. The main storage device 82 and the auxiliary storage device 83 store an operating system (OS) as well besides program to realize the “ . . . units” in FIG. 1. Then, at least a part of the OS is executed by a processor 11. The arithmetic processing unit 81 executes the program to realize the functions of the “ . . . units” in FIG. 1 while executing at least a part of the OS. In FIG. 2, one arithmetic processing unit 81 is illustrated; however, the pressure loss determination device 1 may include a plurality of arithmetic processing units 81. Additionally, information, data, signal values or variable values indicating the results of the processing by the “ . . . units” in FIG. 1 are stored in the main storage devices 82 and the auxiliary storage device 83, or registers or cache memories in the arithmetic processing unit 81. Further, the program to realize the functions of the “ . . . units” in FIG. 1 may be stored in a portable recording medium such as a magnetic disk, a flexible disk, an optical disc, a compact disk, a blue-ray (registered trademark) disc, a digital versatile disc (DVD), etc., or a program product.

Further, the “ . . . units” in FIG. 1 may be replaced with “circuits,” “steps,” “procedures” or “processing.” Furthermore, the pressure loss determination device 1 may be realized by electronic circuits such as logic integrated circuits (logic ICs), gate arrays (GAs), application specific integrated circuits (ASICs) or field-programmable gate arrays (FPGAs), etc. In this case, the “ . . . units” in FIG. 1 are respectively realized as parts of electronic circuits. The processors and the electronic circuits as described above are collectively referred to as “processing circuitry” as well.

### REFERENCE SIGNS LIST

1: pressure loss determination device; 2: BIM information storage device; 3: piping information storage device; 4: display device; 5: pipe space; 6: indoor unit; 10: BIM information management unit; 20: Z piping arrangement unit; 30: route trace unit; 40: loss determination unit; 41: plane; 41S: starting point cell; 41E: end point cell; 41a: one cell; 41b: another cell; 41c: upstream cell; 42: X loss map; 43: X queue; 44: X starting point map; 45: Y loss map; 46: Y queue; 47: Y starting point map; 50: piping information management unit; 51: loss information; 60: XY piping arrangement unit; 81: arithmetic processing unit; 82: main storage device; 83: auxiliary storage device; 84: interface device; 85: input I/F; 86: display I/F; 87: input device; 88: display device; 91: division unit; 92: loss information storage unit; 93: pipe space

1-6. (canceled)

7. A pressure loss determination device comprising:
processing circuitry to:
extract a plane in two dimensions whereon a pipe is to be arranged, from building information in three dimensions into which a building is made into data, to divide the plane extracted into meshes, to be divided into a plurality of cells, and to set a starting point cell being a starting point of the pipe and an end point cell being an end point of the pipe of the plurality of cells;
store, in a case wherein a fluid flows from one cell to another cell being adjacent to the one cell of the plurality of cells via the pipe, loss information indicating a pressure loss value of the fluid between cells; and
search for a plurality of piping routes formed by a connection of the cells from the starting point cell to the end point cell, and determine a pressure loss value in a case wherein the fluid flows from the starting point cell to the end point cell, with respect to each piping route of the plurality of piping routes, using the loss information.

8. The pressure loss determination device as defined in claim 7,
wherein in the loss information, pressure loss values of the fluid between the one cell and the other cell are different between a case wherein the one cell, the other cell, and an upstream cell being adjacent to the one cell on an upstream side, from which the fluid flows into the one cell, are arranged linearly, and a case wherein the one cell and the other cell are arranged linearly but the upstream cell is adjacent to the one cell in either of a right direction or a left direction relative to a direction from the one cell to the other cell.

9. The pressure loss determination device as defined in claim 7,
wherein the processing circuitry generates a starting point map wherein a coordinate corresponding to a coordinate on the plane that is divided into meshes is set;
determines, using the loss information, a pressure loss value of the fluid in each cell in each piping route on the plane when the plurality of piping routes are searched for, and sets a coordinate value of a cell being a starting point for determination of the pressure loss value determined, in a coordinate of the starting point map corresponding to a coordinate of the cell for which the pressure loss value is determined; and
executes a back-trace of the piping route from the end point cell to the starting point cell, using the starting point map.

10. The pressure loss determination device as defined in claim 8,
wherein the processing circuitry generates a starting point map wherein a coordinate corresponding to a coordinate on the plane that is divided into meshes is set;
determines, using the loss information, a pressure loss value of the fluid in each cell in each piping route on the plane when the plurality of piping routes are searched for, and sets a coordinate value of a cell being a starting point for determination of the pressure loss value determined, in a coordinate of the starting point map corresponding to a coordinate of the cell for which the pressure loss value is determined; and
executes a back-trace of the piping route from the end point cell to the starting point cell, using the starting point map.

11. The pressure loss determination device as defined in claim 7,
wherein the processing circuitry extracts the plane using information of a pipe space, which is arranged in a height direction of the building to extend across floors of the building, inside of which a pipe is arranged, the information being included in the building information, and information of an indoor unit for which a pipe is provided, the information being included in the building information.

12. The pressure loss determination device as defined in claim 8,
wherein the processing circuitry extracts the plane using information of a pipe space, which is arranged in a height direction of the building to extend across floors of the building, inside of which a pipe is arranged, the information being included in the building information, and information of an indoor unit for which a pipe is provided, the information being included in the building information.

13. The pressure loss determination device as defined in claim 9,
wherein the processing circuitry extracts the plane using information of a pipe space, which is arranged in a height direction of the building to extend across floors of the building, inside of which a pipe is arranged, the information being included in the building information, and information of an indoor unit for which a pipe is provided, the information being included in the building information.

14. The pressure loss determination device as defined in claim 10,
wherein the processing circuitry extracts the plane using information of a pipe space, which is arranged in a height direction of the building to extend across floors of the building, inside of which a pipe is arranged, the information being included in the building information, and information of an indoor unit for which a pipe is provided, the information being included in the building information.

15. A non-transitory computer readable medium storing a pressure loss determination program to make a computer execute:
a process to extract a plane in two dimensions whereon a pipe is to be arranged, from building information in three dimensions, to divide the plane extracted into meshes, to be divided into a plurality of cells, and to set a starting point cell being a starting point of the pipe and an end point cell being an end point of the pipe of the plurality of cells;
a process to store in a storage device, in a case wherein a fluid flows from one cell to another cell being adjacent to the one cell of the plurality of cells, via the pipe, loss information indicating a pressure loss value of the fluid between cells; and
a process to search for a plurality of piping routes formed by a connection of the cells from the starting point cell to the end point cell, and to determine a pressure loss value in a case wherein the fluid flows from the starting point cell to the end point cell, with respect to each piping route of the plurality of piping routes, using the loss information.

16. A pressure loss determination method comprising:
extracting a plane in two dimensions whereon a pipe is to be arranged, from building information in three dimensions, dividing the plane extracted into meshes, to be divided into a plurality of cells, and setting a starting point cell being a starting point of the pipe and an end point cell being an end point of the pipe of the plurality of cells;
storing in a memory, in a case wherein a fluid flows from one cell to another cell being adjacent to the one cell of the plurality of cells, via the pipe, loss information indicating a pressure loss value of the fluid between cells; and
searching for a plurality of piping routes formed by a connection of the cells from the starting point cell to the end point cell, and determining a pressure loss value in a case wherein the fluid flows from the starting point cell to the end point cell, with respect to each piping route of the plurality of piping routes, using the loss information.
